(19) United States
(12) Patent Application Publication
(10) Pub. No.: US 2025/0094319 A1
(43) Pub. Date: Mar. 20, 2025

(54) Apparatus For Development And Method Thereof

(71) Applicants: Hyundal Motor Company, Seoul (KR); Kia Corporation, Seoul (KR)

(72) Inventors: Ui Jung Jung, Hwaseong-si (KR); Myeong Gwan Kim, Goyang-Si (KR)

(21) Appl. No.: 18/437,533

(22) Filed: Feb. 9, 2024

(30) Foreign Application Priority Data
Sep. 14, 2023 (KR) 10-2023-0122707

(51) Int. Cl. G06F 11/36

(52) U.S. Cl. CPC G06F 11/3672; G06F 11/3696

(57) ABSTRACT

Disclosed is an apparatus, which includes one or more processors and memory. The apparatus obtains an application core developed in a first operating system. The application core includes control logic of a vehicle. The apparatus tests the application core by applying a first wrapper, which includes a functional cluster of an automotive open system architecture (AUTOSAR) platform and is executable in the first operating system, to the application core, and generates an adaptive application by applying a second wrapper, which includes the functional cluster and is executable in a second operating system different from the first operating system, to the application core, based on the testing of the application core. The adaptive application is classifiable as an executable file on the AUTOSAR platform.

### CROSS-REFERENCE TO RELATED APPLICATION

This application claims the benefit of priority to Korean Patent Application No. 10-2023-0122707, filed in the Korean Intellectual Property Office on Sep. 14, 2023, the entire contents of which are incorporated herein by reference.

### TECHNICAL FIELD

The present disclosure relates to a development apparatus and development method, and more particularly, relates to technology for an adaptive development platform.

### BACKGROUND

The AUTOSAR (AUTomotive Open System Architecture) platform, an international standard applied to effectively perform computational processing and improve development convenience in response to changes in vehicle architecture, is being applied to vehicle controllers. The AUTOSAR platform may be available in two varieties: an classic AUTOSAR platform (also referred to as AUTOSAR Classic Platform), which uses a microcontroller unit (MCU) to meet real-time requirements, and an adaptive AUTOSAR platform (also referred to as AUTOSAR Adaptive Platform), which is implemented with a high-performance processor.

Due to the development characteristics of the adaptive AUTOSAR platform (hereinafter referred to as adaptive AUTOSAR) among the AUTOSAR platforms, Application Software Layer (ASW) developers have no choice but to have dependency on a Basic Software Layer (BSW). As a result, efficiency of the adaptive AUTOSAR development may suffer, and it may be difficult to take advantage of application reusability, which is one of the strengths of the adaptive AUTOSAR.

In particular, for communication between objects, adaptive AUTOSAR includes an internal structure that communicates with a Proxy-Skeleton service interface structure through service-based service-oriented architecture (SOA)) rather than a signal-based communication of classic AUTOSAR. In addition, since adaptive AUTOSAR includes functional clusters (FC) with various functions, it is essential for the ASW developers to understand the internal modules.

To solve these problems, it may be advantageous to have an improved adaptive AUTOSAR platform that only requires the ASW developers to understand a wrapper structure and allow them to focus on developing the application logic.

### SUMMARY

The present disclosure has been made to solve the above-mentioned problems occurring in some implementations while advantages achieved in those implementations are maintained intact.

An aspect of the present disclosure provides a development apparatus and development method that allows ASW developers to accelerate a development of logical application programs through an Agile and a Test Driven Development, by performing a test of an application core by applying a first wrapper capable of being executed in a first operating system such as a Windows operating system, to the application core.

In addition, an aspect of the present disclosure provides a development apparatus and development method that allows the ASW developers to easily and quickly develop adaptive applications even without knowledge of an adaptive AUTOSAR or a Linux operating system, by applying a second wrapper capable of being executed in a second operating system such as the Linux operating system to the application core, and generating an adaptive application that may be classified as an executable file on the adaptive AUTOSAR.

In addition, an aspect of the present disclosure provides a development apparatus and development method that may generate an adaptive application with the same application core even when the version of the adaptive AUTOSAR is changed and may ensure the reusability of the application core, by applying the adaptive application generated using the first wrapper and the second wrapper to the AUTOSAR to perform the control logic included in the application core.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus may include: one or more processors; and memory storing instructions that, when executed by the one or more processors, cause the apparatus to: obtain an application core developed in a first operating system. The application core may include control logic of a vehicle. The instructions, when executed by the one or more processors, may further cause the apparatus to: test the application core by applying a first wrapper, which includes a functional cluster of an automotive open system architecture (AUTOSAR) platform and is executable in the first operating system, to the application core; and generate an adaptive application by applying a second wrapper, which includes the functional cluster and is executable in a second operating system different from the first operating system, to the application core, based on the testing of the application core. The adaptive application may be classifiable as an executable file on the AUTOSAR platform.

The instructions, when executed by the one or more processors, may further cause the apparatus to: extract, based on a standard document format of the AUTOSAR platform, the functional cluster from settings data of a basic software layer; generate the first wrapper. The first wrapper may be capable of providing, in the first operating system, the functional cluster to the application core. The instructions, when executed by the one or more processors, may further cause the apparatus to: generate the second wrapper. The second wrapper may be capable of providing, in the second operating system, the functional cluster to the application core.

The instructions, when executed by the one or more processors, may further cause the apparatus to: obtain interfaces corresponding to a plurality of functions included in the functional cluster; generate an abstract wrapper including a definition of each of the interfaces; and generate each of the first wrapper and the second wrapper such that the each of the first wrapper and the second wrapper is capable of referring to the interfaces that are included in the abstract wrapper.

The second wrapper may reference a proxy-skeleton interface included in the abstract wrapper.

The instructions, when executed by the one or more processors, may cause the apparatus to test the application core by: obtaining, from a test vector corresponding to the control logic of the vehicle, a test input by applying the test vector to the first wrapper; obtaining a test output from the application core by applying the test input and the first wrapper to the application core; and comparing an expected output of the test input with the test output.

The instructions, when executed by the one or more processors, may cause the apparatus to generate the adaptive application by: applying the first wrapper to each of a plurality of application cores to perform a test on each of the plurality of application cores; combining, based on the test of the each of the plurality of application cores, the plurality of application cores to obtain a representative application core; and applying the second wrapper to the representative application core.

The control logic may be included in the application core. The instructions, when executed by the one or more processors, may cause the apparatus to test the application core by: dividing the control logic into a plurality of software components; and applying the first wrapper to the plurality of software components.

The instructions, when executed by the one or more processors, may further cause the apparatus to: invoke a plurality of threads, whose quantity is equal to a quantity of software components in the plurality of software components; and execute, via a different one of the plurality of threads, each of the plurality of software components.

The control logic may be included in the application core. The instructions, when executed by the one or more processors, may further cause the apparatus to: perform the control logic by applying the adaptive application to the AUTOSAR platform.

The first operating system may include a Windows operating system. The second operating system may include a Linux operating system that meets a portable operating system interface (POSIX) standard.

According to one or more example embodiments of the present disclosure, a development method may include: obtaining an application core developed in a first operating system. The application core may include control logic of a vehicle. The development method may further comprise: testing the application core by applying a first wrapper, which includes a functional cluster of an automotive open system architecture (AUTOSAR) platform and is executable in the first operating system, to the application core; and generating an adaptive application by applying a second wrapper, which includes the functional cluster and is executable in a second operating system different from the first operating system, to the application core, based on the testing of the application core. The adaptive application may be classifiable as an executable file on the AUTOSAR platform.

The development method may further include: extracting, based on a standard document format of the AUTOSAR platform, the functional cluster from settings data of a basic software layer; generating the first wrapper. The first wrapper may be capable of providing, in the first operating system, the functional cluster to the application core. The development method may further include generating the second wrapper. The second wrapper may be capable of providing, in the second operating system, the functional cluster to the application core.

The development method may further include: obtaining interfaces corresponding to a plurality of functions included in the functional cluster; generating an abstract wrapper including a definition of each of the interfaces; and generating each of the first wrapper and the second wrapper such that the each of the first wrapper and the second wrapper is capable of referring to the interfaces that are included in the abstract wrapper.

The second wrapper may reference a proxy-skeleton interface included in the abstract wrapper.

Testing the application core may include: obtaining, from a test vector corresponding to the control logic of the vehicle, a test input by applying the test vector to the first wrapper; obtaining a test output from the application core by applying the test input and the first wrapper to the application core; and comparing an expected output of the test input with the test output.

Generating the adaptive application may include: applying the first wrapper to each of a plurality of application cores to perform a test on each of the plurality of application cores; combining, based on the test of the each of the plurality of application cores, the plurality of application cores to obtain a representative application core; and applying the second wrapper to the representative application core.

The control logic may be included in the application core. Testing the application core may include: dividing the control logic into a plurality of software components; and applying the first wrapper to the plurality of software components.

The development method may further include: invoking a plurality of threads, whose quantity is equal to a quantity of software components in the plurality of software components; and executing, via a different one of the plurality of threads, each of the plurality of software components.

The control logic may be included in the application core. The method may further include: performing the control logic by applying the adaptive application to the AUTOSAR platform.

The first operating system may include a Windows operating system. The second operating system may include a Linux operating system that meets a portable operating system interface (POSIX) standard.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a development apparatus;

FIG. 2 is a flowchart for describing a development method;

FIG. 3 is a diagram illustrating a method of testing an application core in a virtual environment and applying an application core in a real environment in a development apparatus;

FIG. 4 is a diagram illustrating a method of applying a first wrapper to an application core in a development apparatus;

FIG. 5 is a diagram illustrating a method of applying a second wrapper to an application core in a development apparatus;

FIG. 6A is a diagram illustrating a method in which a first wrapper is applied to an application core with reference to an abstract wrapper in a development apparatus;

FIG. 6B is a diagram illustrating a method in which a second wrapper is applied to an application core with reference to an abstract wrapper in a development apparatus;

FIG. 7 is a diagram illustrating a method of applying a wrapper in units of software components in a development apparatus;

FIG. 8 is a diagram illustrating a method of obtaining a representative application core in a development apparatus;

FIG. 9 is a flowchart illustrating a method of applying each of a first wrapper and a second wrapper to an application core in a development apparatus;

FIG. 10 is a flowchart illustrating a method of applying each of a first wrapper and a second wrapper to an application core and utilizing a development storage in a development apparatus; and

FIG. 11 is a diagram illustrating a computing system related to a development apparatus or development method.

In connection with the description of the drawings, the same or similar reference numerals may be used for the same or similar components.

### DETAILED DESCRIPTION

Hereinafter, one or more example embodiments of the present disclosure will be described in detail with reference to the accompanying drawings. In adding the reference numerals to the components of each drawing, it should be noted that the identical or equivalent component is designated by the identical numeral even when they are displayed on other drawings. In addition, a detailed description of well-known features or functions will be ruled out in order not to unnecessarily obscure the gist of the present disclosure. Particularly, one or more example embodiments of the present disclosure may be described with reference to accompanying drawings. Accordingly, those of ordinary skill in the art will recognize that modification, equivalent, and/or alternative on the example embodiments described herein may be variously made without departing from the scope and spirit of the present disclosure. With regard to description of drawings, similar components may be marked by similar reference numerals.

In describing components of one or more example embodiments of the present disclosure, the terms first, second, A, B, (a), (b), and the like may be used herein. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. For example, expressions such as “first”, “second”, or the like used herein may indicate various components regardless of order and/or importance, and are only used to distinguish one component from another component and do not limit the components. For example, “a first user device” and “a second user device” may indicate different user devices regardless of the order or priority thereof. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” used herein indicate existence of corresponding features (e.g., elements such as numeric values, functions, operations, or components) but do not exclude presence of additional features. It should be understood that when a component (e.g., first component) is referred to as being “operatively or communicatively coupled with/to” or “connected to” another component (e. g., a second component), the component may be directly connected to the other component or may be connected through another component (e.g., a third component). In contrast, when a component (e.g., a first component) is referred to as being “directly coupled with/to” or “directly connected to” another component (e.g., a second component), it should be understood that there are no intervening component (e.g., a third component).

According to the situation, the expression “configured to” used herein may be used as, for example, the expression “suitable for”, “having the capacity to”, “designed to”, “adapted to”, “made to”, or “capable of”.

The term “configured to (or set to)” should not mean only “specifically designed to” in hardware”. Instead, in some situations, the expression “device configured to” may mean that the device is “capable of” working with other devices or components. For example, the phrase “processor configured to (or set to) perform A, B, and C” may mean a dedicated processor (e.g., an embedded processor) for performing a corresponding operation or a generic-purpose processor (e.g., a central processing unit (CPU) or an application processor) which is capable of performing corresponding operations by executing one or more software programs which are stored in a memory device.

Terms used in the specification are used to describe example embodiments of the present disclosure and may be not intended to limit the scope of other embodiments. Singular expressions may include plural expressions unless the context clearly indicates otherwise. All the terms used herein, which include technical or scientific terms, may have the same meaning that is generally understood by a person skilled in the art described in the specification. It will be further understood that terms, which are defined in a dictionary and commonly used, should also be interpreted as is customary in the relevant related art and not in an idealized or overly formal sense unless expressly so defined herein in various embodiments of the present disclosure. In some cases, even though terms are terms which are defined in the specification, they may not be interpreted to exclude embodiments of the present disclosure.

In the disclosure disclosed herein, the expressions “A or B”,” “at least one of A or/and B”, or “one or more of A or/and B”, and the like may include any and all possible combinations of items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

In addition, in describing the components of example embodiments of the present disclosure, each of the phrases “A or B”, “at least one of A and B”, “at least one of A or B”, “A, B or C”, “at least one of A, B and C”, “at least one of A, B, or C”, and “at least one of A, B, C, or any combination thereof” may include any one of the items listed together with the corresponding phrase of the phrases, or any possible combination thereof. In particular, the phrase such as “at least one of A, B, C, or any combination thereof” may include A or B or C or a combination thereof such as AB or ABC.

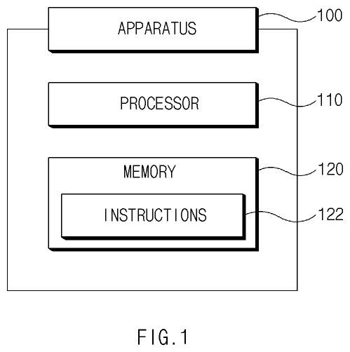

Hereinafter, one or more example embodiments of the present disclosure will be described in detail with reference to FIGS. 1 to 11.

FIG. 1 is a diagram illustrating a development apparatus.

A development apparatus 100 may include a processor 110 and a memory 120 including instructions 122.

The development apparatus 100 may represent a development apparatus that provides and/or applies a wrapper to an application core such that a developer may develop an adaptive application that may be classified as an executable file on an adaptive AUTOSAR platform. In addition, the development apparatus 100 may represent a development apparatus that provides and/or applies a wrapper to the application core such that an adaptive application may be executed on the adaptive AUTOSAR platform.

First, the development apparatus 100 includes control logic of a vehicle and may obtain an application core developed in the first operating system.

The control logic of the vehicle may include a software architecture for controlling the vehicle. In detail, the control logic of the vehicle may include at least one or more software architectures performed on the adaptive AUTOSAR platform when an adaptive application including an application core is executed on the adaptive AUTOSAR platform.

A first operating system may include an operating system in an environment in which a developer develops an application core. In this specification, for convenience of description, the first operating system will be mainly described as a Windows operating system used by most developers for software development.

The application core may be source code containing vehicle control logic implemented as pure functions and/or services from the adaptive AUTOSAR, which is dependent on the adaptive AUTOSAR platform on a Linux operating system.

The development apparatus 100 may perform a test of the application core by applying a first wrapper that includes a functional cluster of the AUTOSAR and may be executed in the first operating system to the application core.

The first wrapper may include codes that depend on the adaptive AUTOSAR platform. In detail, the first wrapper may represent a library of the adaptive AUTOSAR platform for executing the application core in the first operating system environment.

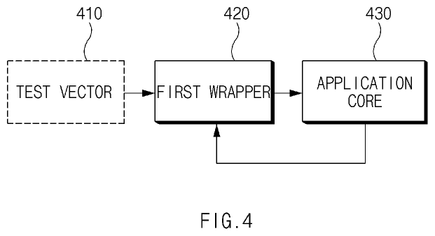

A test of the application core may include temporarily and/or virtually comparing input with output according to the input in the first operating system before the application core is executed in the second operating system. A detailed description regarding this will be provided later in FIG. 4 below.

Based on testing of the application core in the first operating system, the development apparatus 100 may apply a second wrapper that includes a functional cluster of the AUTOSAR and may be executed in a second operating system different from the first operating system, to the application core, and may generate an adaptive application that may be classified as an executable file on the AUTOSAR platform (particularly, the adaptive AUTOSAR platform).

The second wrapper may include codes that depend on the adaptive AUTOSAR platform in the same way as the first wrapper. However, unlike the first wrapper, the second wrapper may represent a library of the adaptive AUTOSAR platform for executing the application core in the second operating system environment.

The second operating system may include an operating system in an environment in which a developer executes an application core. In this specification, for convenience of description, the second operating system will be mainly described as a Linux operating system to which the adaptive AUTOSAR platform may be applied and that complies with a portable operating system interface x (POSIX) standard.

The adaptive application may represent an executable file that executes a specific function (e.g., vehicle control logic included in the application core) of a vehicle control system on the adaptive AUTOSAR platform.

The processor 110 may execute software and may control at least one other component (e.g., hardware or software component) connected to the processor 110. The processor 110 may also perform various data processing or operations. For example, the processor 110 may store an application core, an adaptive application, a first wrapper, and a second wrapper in the memory 120.

For reference, the processor 110 may perform all operations performed by the development apparatus 100. Therefore, for convenience of description, in this specification, operations performed by the development apparatus 100 are mainly described as operations performed by the processor 110. In addition, in this specification, for convenience of description, the processor 110 is mainly described as a single processor, but is not limited thereto. For example, the development apparatus 100 may include at least one or more processors. Each of the at least one or more processors may perform all operations related to the adaptive AUTOSAR platform development operation.

The memory 120 may temporarily and/or permanently store various data and/or information required to perform an adaptive AUTOSAR platform development. For example, the memory 120 may store the application core, the adaptive application, the first wrapper, and the second wrapper.

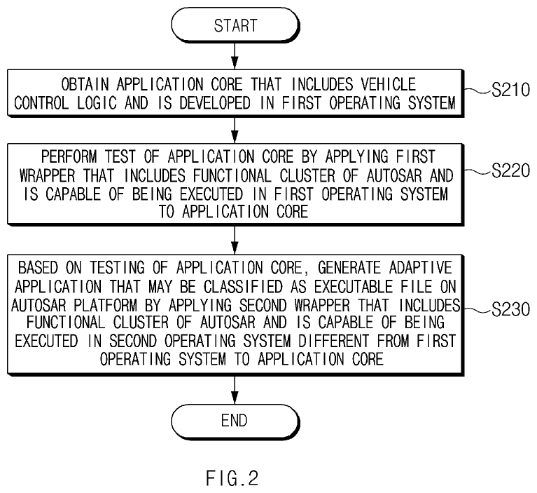

FIG. 2 is a flowchart for describing a development method.

In operation S210, a development apparatus (e.g., the development apparatus 100 of FIG. 1) may obtain an application core that includes vehicle control logic and is developed in the first operating system. For example, a developer may develop an application core in a first operating system. In this case, the developer may develop an application core containing the control logic of the vehicle in the first operating system, regardless of the adaptive AUTOSAR platform.

In operation S220, the development apparatus may perform a test of the application core by applying a first wrapper that includes a functional cluster of the AUTOSAR and may be executed in the first operating system to the application core. For example, the functional cluster of the AUTOSAR may represent a library that may run an adaptive application, which will be described below. In detail, the functional cluster of the AUTOSAR may include an AUTOSAR Runtime for Adaptive Application (ARA). By applying the first wrapper to the application core, the development apparatus may preferentially perform testing of the application core before the application is applied to the adaptive AUTOSAR platform.

In operation S230, the development apparatus, based on testing of the application core, may apply a second wrapper, which includes the functional cluster of the AUTOSAR and is capable of being executed in a second operating system different from the first operating system to the application core, thereby generating the adaptive application that may be classified as an executable file on the AUTOSAR platform. For example, the development apparatus may generate the adaptive application and then may apply the adaptive application to the AUTOSAR platform to perform the vehicle control logic included in the application core.

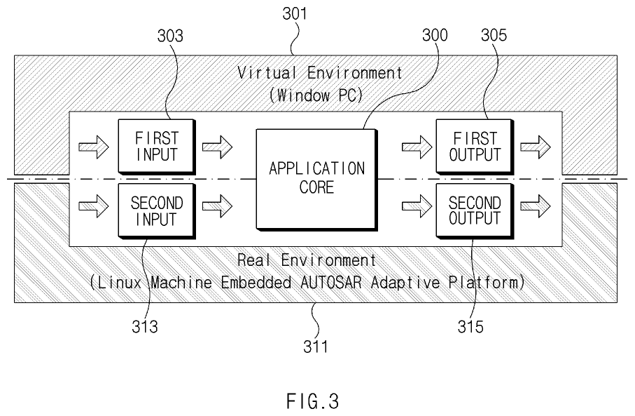

FIG. 3 is a diagram illustrating a method of testing an application core in a virtual environment and applying an application core in a real environment in a development apparatus.

Referring to FIG. 3, FIG. 3 illustrates a software architecture in which a development apparatus (e.g., the development apparatus 100 of FIG. 1) applies wrappers to an application core 300. The development apparatus may symmetrically include a virtual environment 301, which is a virtual development environment, and a real environment 311, which is a real development environment. In this case, the application core 300 may be used equally in both environments, without distinction between the virtual environment 301 and the real environment 311. In contrast, the wrappers may be used as a first wrapper in the virtual environment 301 and as a second wrapper in the real environment 311.

The development apparatus may apply wrappers to the application core 300 in each of the virtual environment 301 and the real environment 311. For example, the virtual environment 301 may represent a virtual development environment in which an application core is developed in a first operating system. In addition, the real environment 311 may represent a real development environment to which the adaptive application generated from the application core 300 is applied on the adaptive AUTOSAR platform running on the second operating system.

For example, the development apparatus may apply the first wrapper to the application core 300 in the virtual environment 301. The development apparatus may use the temporary output obtained by applying a first input 303 to the first wrapper as an input to the application core 300. Thereafter, the development apparatus may obtain a first output 305 corresponding to the above-described temporary output from the application core 300. Thereafter, the development apparatus may apply the first output 305 to the first wrapper. This process is a process in which the development apparatus performs a test of the application core in the virtual environment 301, and will be described in detail in FIG. 4 below.

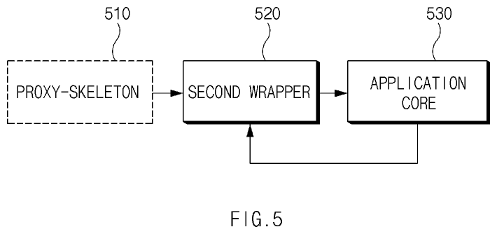

For example, the development apparatus may apply the second wrapper to the application core 300 in the real environment 311. The development apparatus may use the temporary output obtained by applying a second input 313 to the second wrapper as an input to the application core 300. The development apparatus may obtain a second output 315 corresponding to the above-described temporary output from the application core 300. The development apparatus may apply the second output 315 to the second wrapper. This process is a process in which the development apparatus performs a test of the application core in the real environment 311 and generates the adaptive application from the application core, and will be described in detail in FIG. 5 below.

FIG. 4 is a diagram illustrating a method of applying a first wrapper to an application core in a development apparatus.

The development apparatus (e. g., the development apparatus 100 in FIG. 1) obtain a test input from a test vector 410 by applying the test vector 410 to a first wrapper 420. For example, the test vector 410 may represent a vector corresponding to the control logic of the vehicle and may include at least one or more test inputs.

The development apparatus may obtain a test output from an application core 430 by applying the test input and the first wrapper 420 to the application core 430. In this case, the test output may include values expected as output when the test input is applied to the control logics of the vehicle included in the application core 430.

The development apparatus may perform a test of the application core 430 by comparing the expected output corresponding to the test input with the test output. For example, the expected output corresponding to the test input may represent an output that a typical ASW and/or a BSW developer may estimate based on the test input and the application core 430 described above. That is, the expected output corresponding to the test input may include an output that may be obtained when the test input and the vehicle control logic included in the application core 430 are executed on the adaptive AUTOSAR platform.

The development apparatus may complete the test for the test vector 410 when the similarity or identity calculated through comparison of the test output with the expected output of the test input is greater than or equal to a predetermined threshold. The development apparatus may apply the test output to a first wrapper 440 based on when the test for the test vector 410 is completed.

FIG. 5 is a diagram illustrating a method of applying a second wrapper to an application core in a development apparatus.

The development apparatus (e.g., the development apparatus 100 of FIG. 1) may apply a proxy-skeleton 510 to a second wrapper 520. The second wrapper 520 may refer to interfaces for Service Provider-Service Consumer and Proxy-Skeleton for using the Method, Fire & Forget, Event, and Field interfaces of the adaptive AUTOSAR platform. Therefore, the development apparatus may apply the proxy-skeleton 510 to the second wrapper 520, which may refer to the Service Provider-Service Consumer and Proxy-Skeleton interfaces. For reference, an application core 530 illustrated in FIG. 5 may be the same as the application core (e.g., the application core 430 in FIG. 4) on which testing is performed by the development apparatus in FIG. 4.

The development apparatus may apply the second wrapper 520 to the application core 530 based on applying the proxy-skeleton 510 to the second wrapper 520. For example, the development apparatus may obtain messages transmitted and received between a service provider and a consumer) on the adaptive AUTOSAR platform by applying the proxy-skeleton 510 to the second wrapper 520. The development apparatus may apply the obtained message to the input and output of the application core 530 through the second wrapper 520.

In particular, the second wrapper 520 includes codes related to a POSIX OS (e.g., Linux operating system) and may refer to the Service Provider/Consumer and Proxy/Skeleton interfaces. Therefore, the application core 530 does not need to include codes related to the POSIX OS and does not need to include the Service Provider/Consumer and Proxy/Skeleton interfaces. In detail, the application core 530 may include only vehicle control logic implemented as pure functions and/or services.

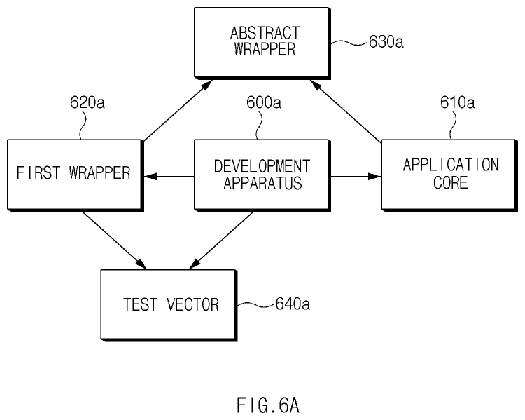

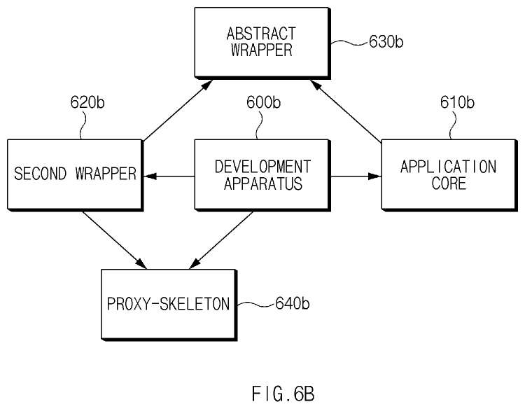

FIG. 6A and FIG. 6B are diagrams illustrating a method in which a first wrapper and a second wrapper are applied to an application core with reference to an abstract wrapper in a development apparatus.

The development apparatus (e. g., the development apparatus 100 of FIG. 1) may obtain interfaces corresponding to a plurality of functions included in the functional cluster of the AUTOSAR. In this case, a plurality of functions included in the functional cluster may represent functions that may be provided by an ARA (AUTOSAR Runtime for Adaptive Application) of the adaptive AUTOSAR platform.

The development apparatus may generate an abstract wrapper that includes definitions of each of the above-described interfaces. In this case, the abstract wrapper may represent an abstract class that may include the same interface definition of a first wrapper for a virtual development environment (e.g., the first wrapper 420 in FIG. 4) and a second wrapper for a real development environment (e.g., the second wrapper 520 in FIG. 5).

The development apparatus may generate each of the first wrapper and the second wrapper such that each of the first wrapper and the second wrapper may refer to the interfaces included in the abstract wrapper. For example, the abstract wrapper may include service interface functions that are pure virtual functions. Each of the first wrapper and the second wrapper may refer to the abstract wrapper and may inherit a service interface function suited to each development environment. Therefore, when there is a change in the environment of the adaptive AUTOSAR platform, the development apparatus may only perform modifications to the abstract wrapper without changing and/or modifying the application core.

Referring to FIG. 6A, a development apparatus 600a may apply a first wrapper 620a to an application core 610a. Additionally, the development apparatus 600a may apply a test vector 640a to the first wrapper 620a and may apply the test input obtained from the test vector 640a to the application core 610a.

The first wrapper 620a may refer to an abstract wrapper 630a (e.g., inherit a service interface function to suit the first operating system environment). For example, the development apparatus 600a may run the application core 610a according to the development environment. The application core 610a may refer to the abstract wrapper 630a through the first wrapper 620a so as to use the service interface function included in the first wrapper 620a.

Referring to FIG. 6B, a development apparatus 600b may apply a second wrapper 620b to an application core 610b. Additionally, the development apparatus 600b may apply a proxy-skeleton 640b to the second wrapper 620b.

The second wrapper 620b may refer (e.g., inherit a service interface function to suit the second operating system environment) to an abstract wrapper 630b. For example, the development apparatus 600b may run the application core 610b according to the development environment. The application core 610b may refer to the abstract wrapper 630b through the second wrapper 620b so as to use the service interface function included in the second wrapper 620b.

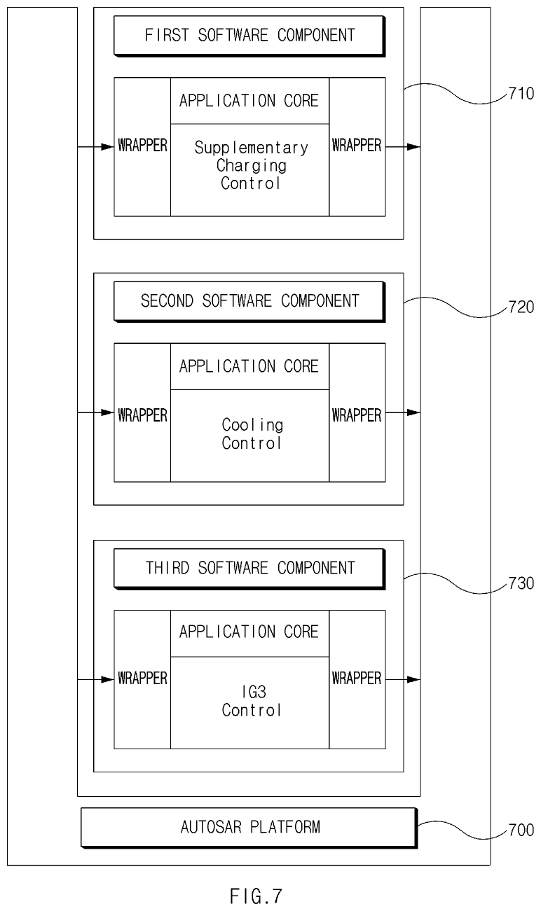

FIG. 7 is a diagram illustrating a method of applying a wrapper in units of software components in a development apparatus.

The development apparatus (e. g., the development apparatus 100 of FIG. 1) may divide a plurality of control logics included in a representative application core in units of software components.

In this case, the software component may be a component that executes the control logic of the vehicle included in the application core on an AUTOSAR platform 700 (particularly, the adaptive AUTOSAR platform). For example, a representative application core may include a plurality of control logics. The development apparatus may divide each of the plurality of control logics included in the representative application core in units of software components to generate an individual application core. In detail, the representative application core may represent an application core including at least two or more control logics, and the individual application core may represent an application core including one control logic.

The development apparatus may apply a wrapper to each of a plurality of individual application cores obtained from the representative application core. The development apparatus may apply wrappers to the individual application cores to generate software component units.

For example, referring to FIG. 7, the representative application core may include supplementary charging control, cooling control, and IG3 control among vehicle control logics. The development apparatus may generate a first software component 710 by applying the wrapper to the supplementary charging control logic. As in the above description, the development apparatus may generate a second software component 720 by applying a wrapper to the cooling control logic, and the development apparatus may generate a third software component 730 by applying a wrapper to the IG3 control logic.

The development apparatus may perform testing of individual application cores by applying the first wrapper to each of the divided software component units. In particular, the development apparatus may invoke threads equal to the number (e.g., 3 in FIG. 7) of divided software component units and may execute each of the divided software component units with respect to each of the invoked threads.

The development apparatus may perform testing of individual application cores while executing each of the divided software component units in units of threads.

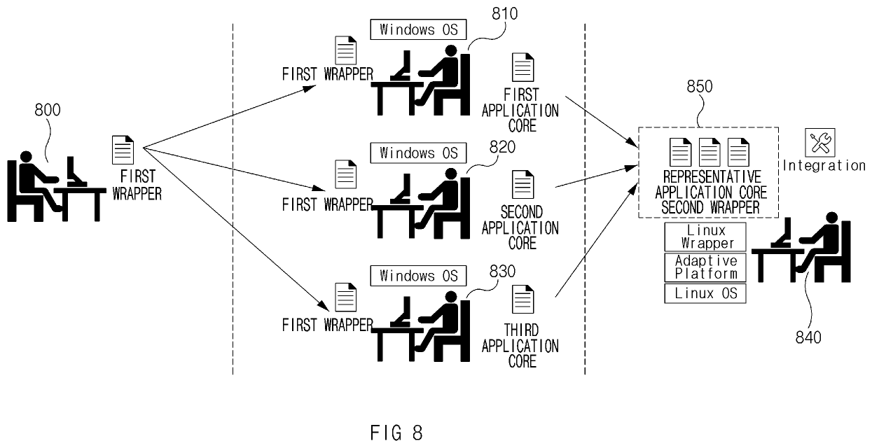

FIG. 8 is a diagram illustrating a method of obtaining a representative application core in a development apparatus.

The development apparatus (e.g., the development apparatus 100 of FIG. 1) may perform tests on each of a plurality of application cores and may obtain a representative application core by combining the plurality of application cores.

For example, a first BSW developer 800 may generate wrapper code that may be executed on the Windows operating system, which is the first operating system. In this case, the wrapper that may be executed on a Windows operating system may represent the first wrapper. Thereafter, the first BSW developer 800 may distribute the first wrapper to at least one or more ASW developers.

For example, in this specification, for convenience of description, at least one or more ASW developers are mainly described as having three people. Each of a first ASW developer 810, a second ASW developer 820, and a third ASW developer 830 may obtain the first wrapper generated by the first BSW developer 800.

Each of the first ASW developer 810, the second ASW developer 820, and the third ASW developer 830 may generate an application core in a Windows operating system environment that is an ASW development environment, a first operating system environment, and a virtual development environment. Thereafter, the development apparatus may apply the first wrapper, which is wrapper code that may be executed in the Windows operating system, which is the first operating system, to the application core generated by each of the first ASW developer 810, the second ASW developer 820, and the third ASW developer 830, to perform the test of the application core.

Thereafter, a second BSW developer 840 may obtain a first application core generated by the first ASW developer 810, a second application core generated by the second ASW developer 820, and a third application core generated by the third ASW developer 830.

In response to a request from the second BSW developer 840, the development apparatus may combine a plurality of application cores to obtain a representative application core. The development apparatus may generate an adaptive application 850 by applying the second wrapper to the representative application core.

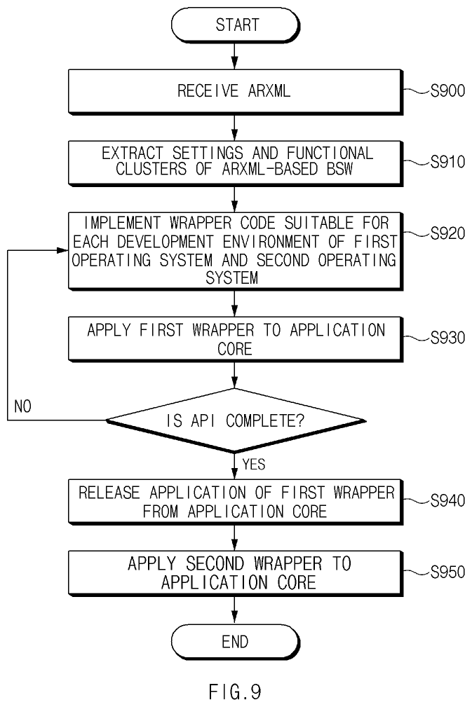

FIG. 9 is a flowchart illustrating a method of applying each of a first wrapper and a second wrapper to an application core in a development apparatus.

Referring to FIG. 9, the development apparatus (e.g., the development apparatus 100 of FIG. 1) may apply a first wrapper and/or a second wrapper to the application core.

In operation S900, the development apparatus may receive an AUTOSAR XML (ARXML). For example, the ARXML may represent a standard file format for describing and representing data between various tools and components within the AUTOSAR platform.

In operation S910, the development apparatus may extract the settings and functional clusters of the ARXML-based BSW. For example, the development apparatus may perform settings for generating the first wrapper that may be executed in the first operating system by extracting the settings of the BSW included in the ARXML. For reference, the settings of the BSW illustrated in FIG. 9 may be the same as the settings of the adaptive AUTOSAR platform.

In operation S920, the development apparatus may implement and/or generate a wrapper code that may be executed in a Windows development environment and a wrapper code that may be executed in a Linux development environment. For example, the development apparatus may generate a first wrapper that may be executed in a Windows development environment based on the settings of the extracted BSW. As in the above description, the development apparatus may generate a second wrapper that may be executed in a Linux development environment based on the settings of the extracted BSW. In particular, the development apparatus may generate a first wrapper that includes functional clusters and to which test vectors may be applied. In addition, the development apparatus may generate a second wrapper that includes functional clusters and to which the proxy-skeleton may be applied.

In operation S930, the development apparatus may apply the first wrapper to the application core. The development apparatus may perform testing of the application core by applying the first wrapper to the application core. Thereafter, the development apparatus may determine whether an API is complete by performing a test of the application core.

In operation S940, the development apparatus may release the application of the first wrapper from the application core based on when the API is completed. For example, the development apparatus may release the application of the first wrapper from the application core by excluding and/or deleting the portion or area to which the first wrapper is applied from the application core to which the first wrapper is applied.

In operation S950, the development apparatus may apply the second wrapper to the application core. For example, the development apparatus may, based on testing (e.g., included in operations S930 to S940) of the application core, generate an adaptive application that may be classified as an executable file on the AUTOSAR platform by applying the second wrapper that includes a functional cluster of AUTOSAR and may be executed a second operating system that is different from the first operating system, to the application core. Thereafter, the development apparatus may apply the adaptive application to the AUTOSAR platform to perform the control logic included in the application core.

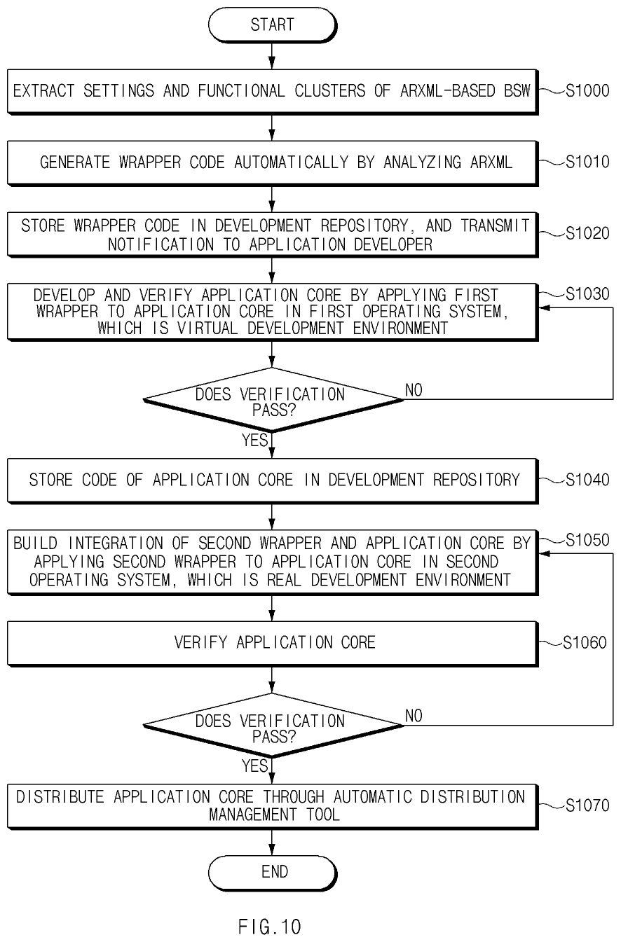

FIG. 10 is a flowchart illustrating a method of applying each of a first wrapper and a second wrapper to an application core and utilizing a development storage in a development apparatus.

In operation S1000, the development apparatus (e.g., the development apparatus 100 in FIG. 1) may extract the settings and functional clusters of the ARXML-based BSW.

In operation S1010, the development apparatus may use ARXML as input and may output a wrapper code. For example, the development apparatus may extract the settings and functional clusters of the BSW included in the ARXML and may automatically generate the wrapper code by analyzing the settings and functional clusters of the extracted BSW.

In operation S1020, the development apparatus may store the above-described wrapper code in a development repository. In addition, the development apparatus may transmit a notification to the application developer (e.g., ASW developer) based on the case where the wrapper code is stored in the development repository.

In operation S1030, the development apparatus may perform a test of the application core by applying the first wrapper to the application core in the first operating system, which is a virtual development environment, in response to the developer or a request from the developer.

In operations S1040 to S1060, the development apparatus may store the code of the application core in the development repository based on when testing or verification of the application core is completed. Thereafter, the development apparatus may build the application cores by applying the second wrapper to the application core in a real development environment. The development apparatus may verify the built application core.

In operation S1070, the development apparatus may perform distribution of the application core through an automatic distribution management tool, based on the case where verification of the built application core is completed.

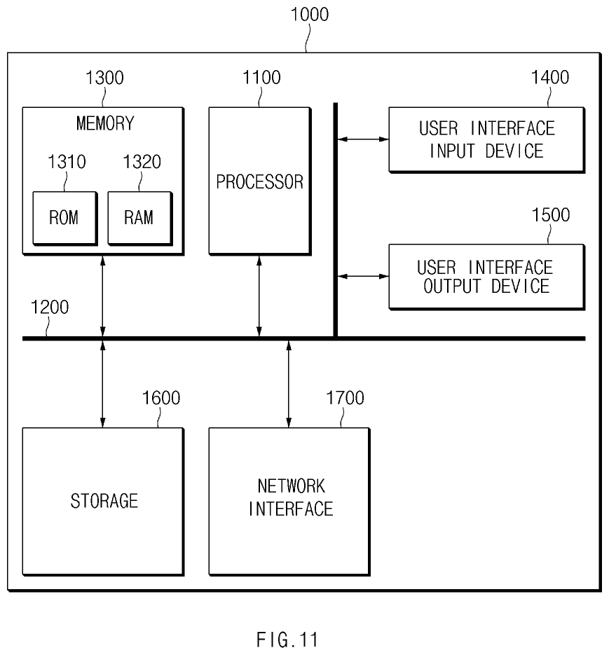

FIG. 11 is a diagram illustrating a computing system related to a development apparatus or development method.

Referring to FIG. 11, a computing system 1000 related to a development apparatus or development method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the example embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium as an example may be coupled to the processor 1100. The processor 1100 may read out information from the storage medium and may write information into the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely illustrative of the technical idea of the present disclosure, and those of ordinary skill in the art to which the present disclosure pertains will be able to make various modifications and variations without characteristics of the present departing from the essential disclosure.

The above-described example embodiments may be implemented with hardware elements, software elements, and/or a combination of hardware elements and software elements. For example, the devices, methods, and elements described in the example embodiments may be implemented by using one general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing device may include a plurality of processors or one processor and one controller. Also, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be stored in a computer-readable recording medium.

The methods according to the above-described example embodiments of the inventive concept may be recorded in a computer-readable medium including program instructions that are executable through various computer devices. The computer-readable medium may include program instructions, data files, data structures, etc., singly or in combination, and the program instructions recorded on the medium may be specially designed and constructed for the one or more example embodiment or may be known and available to those skilled in the art of computer software. The computer-readable medium may include magnetic media such as hard disks, floppy disks, and magnetic tapes, optical media such as CD-ROMs and DVDs, magneto-optical media such as floptical disks, and hardware devices that are specially configured to store and execute program instructions, such as ROMs, RAMS, flash memories, etc., as an example. Examples of computer programs include not only machine language codes generated by a compiler, but also high-level language codes that are capable of being executed by a computer by using an interpreter or the like.

The above-described hardware devices may be configured to act as one or a plurality of software modules to perform the operations of the above-described example embodiments of the present disclosure, or vice versa.

Even though the example embodiments are limitedly described with reference to drawings, it may be obviously to one skilled in the art that the example embodiments are variously changed or modified based on the above description. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents of the claims also fall within the scope of the claims described below.

The effects of the development apparatus and development method according to the present disclosure will be described as follows.

According to at least one of the example embodiments of the present disclosure, the development apparatus and development method may have the effect of allowing the ASW developers to accelerate a development of logical application programs through the Agile and the Test Driven Development, by performing a test of an application core by applying the first wrapper capable of being executed in a first operating system such as a Windows operating system, to the application core.

In addition, according to at least one of the example embodiments of the present disclosure, the development apparatus and development method may have the effect of allowing the ASW developers to easily and quickly develop adaptive applications even without knowledge of an adaptive AUTOSAR or a Linux operating system, by applying the second wrapper capable of being executed in a second operating system such as the Linux operating system to the application core, and generating an adaptive application that may be classified as an executable file on the adaptive AUTOSAR.

In addition, according to at least one of the example embodiments of the present disclosure, the development apparatus and development method may have the effect of generating an adaptive application with the same application core even when the version of the adaptive AUTOSAR is changed and ensuring the reusability of the application core, by applying the adaptive application generated using the first wrapper and the second wrapper to the AUTOSAR to perform the control logic included in the application core.

In addition to this, various effects identified directly or indirectly through this specification may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
one or more processors; and
memory storing instructions that, when executed by the one or more processors, cause the apparatus to:
obtain an application core developed in a first operating system, wherein the application core comprises control logic of a vehicle;
test the application core by applying a first wrapper, which comprises a functional cluster of an automotive open system architecture (AUTOSAR) platform and is executable in the first operating system, to the application core; and
generate an adaptive application by applying a second wrapper, which comprises the functional cluster and is executable in a second operating system different from the first operating system, to the application core, based on the testing of the application core, wherein the adaptive application is classifiable as an executable file on the AUTOSAR platform.

2. The apparatus of claim 1, wherein the instructions, when executed by the one or more processors, further cause the apparatus to:
extract, based on a standard document format of the AUTOSAR platform, the functional cluster from settings data of a basic software layer;
generate the first wrapper, wherein the first wrapper is capable of providing, in the first operating system, the functional cluster to the application core; and
generate the second wrapper, wherein the second wrapper is capable of providing, in the second operating system, the functional cluster to the application core.

3. The apparatus of claim 2, wherein the instructions, when executed by the one or more processors, further cause the apparatus to:
obtain interfaces corresponding to a plurality of functions included in the functional cluster;
generate an abstract wrapper comprising a definition of each of the interfaces; and
generate each of the first wrapper and the second wrapper such that the each of the first wrapper and the second wrapper is capable of referring to the interfaces that are included in the abstract wrapper.

4. The apparatus of claim 3, wherein the second wrapper references a proxy-skeleton interface included in the abstract wrapper.

5. The apparatus of claim 1, wherein the instructions, when executed by the one or more processors, cause the apparatus to test the application core by:
obtaining, from a test vector corresponding to the control logic of the vehicle, a test input by applying the test vector to the first wrapper;
obtaining a test output from the application core by applying the test input and the first wrapper to the application core; and
comparing an expected output of the test input with the test output.

6. The apparatus of claim 1, wherein the instructions, when executed by the one or more processors, cause the apparatus to generate the adaptive application by:
applying the first wrapper to each of a plurality of application cores to perform a test on each of the plurality of application cores;
combining, based on the test of the each of the plurality of application cores, the plurality of application cores to obtain a representative application core; and
applying the second wrapper to the representative application core.

7. The apparatus of claim 1, wherein the control logic is included in the application core, and wherein the instructions, when executed by the one or more processors, cause the apparatus to test the application core by:
dividing the control logic into a plurality of software components; and
applying the first wrapper to the plurality of software components.

8. The apparatus of claim 7, wherein the instructions, when executed by the one or more processors, further cause the apparatus to:
invoke a plurality of threads, whose quantity is equal to a quantity of software components in the plurality of software components; and
execute, via a different one of the plurality of threads, each of the plurality of software components.

9. The apparatus of claim 1, wherein the control logic is included in the application core, and wherein the instructions, when executed by the one or more processors, further cause the apparatus to:
perform the control logic by applying the adaptive application to the AUTOSAR platform.

10. The apparatus of claim 1, wherein the first operating system comprises a Windows operating system, and
wherein the second operating system comprises a Linux operating system that meets a portable operating system interface (POSIX) standard.

11. A development method comprising:
obtaining an application core developed in a first operating system, wherein the application core comprises control logic of a vehicle;
testing the application core by applying a first wrapper, which comprises a functional cluster of an automotive open system architecture (AUTOSAR) platform and is executable in the first operating system, to the application core; and
generating an adaptive application by applying a second wrapper, which comprises the functional cluster and is executable in a second operating system different from the first operating system, to the application core, based on the testing of the application core, wherein the adaptive application is classifiable as an executable file on the AUTOSAR platform.

12. The development method of claim 11, further comprising:
extracting, based on a standard document format of the AUTOSAR platform, the functional cluster from settings data of a basic software layer;
generating the first wrapper, wherein the first wrapper is capable of providing, in the first operating system, the functional cluster to the application core; and
generating the second wrapper, wherein the second wrapper is capable of providing, in the second operating system, the functional cluster to the application core.

13. The development method of claim 12, further comprising:
obtaining interfaces corresponding to a plurality of functions included in the functional cluster;
generating an abstract wrapper comprising a definition of each of the interfaces; and
generating each of the first wrapper and the second wrapper such that the each of the first wrapper and the second wrapper is capable of referring to the interfaces that are included in the abstract wrapper.

14. The development method of claim 13, wherein the second wrapper references a proxy-skeleton interface included in the abstract wrapper.

15. The development method of claim 11, wherein the testing of the application core comprises:
obtaining, from a test vector corresponding to the control logic of the vehicle, a test input by applying the test vector to the first wrapper;
obtaining a test output from the application core by applying the test input and the first wrapper to the application core; and
comparing an expected output of the test input with the test output.

16. The development method of claim 11, wherein the generating of the adaptive application comprises:
applying the first wrapper to each of a plurality of application cores to perform a test on each of the plurality of application cores;
combining, based on the test of the each of the plurality of application cores, the plurality of application cores to obtain a representative application core; and
applying the second wrapper to the representative application core.

17. The development method of claim 11, wherein the control logic is included in the application core, and wherein the testing of the application core comprises:
dividing the control logic into a plurality of software components; and
applying the first wrapper to the plurality of software components.

18. The development method of claim 17, further comprises:
invoking a plurality of threads, whose quantity is equal to a quantity of software components in the plurality of software components; and
executing, via a different one of the plurality of threads, each of the plurality of software components.

19. The development method of claim 11, wherein the control logic is included in the application core, and wherein the method further comprises:
performing the control logic by applying the adaptive application to the AUTOSAR platform.

20. The development method of claim 11, wherein the first operating system comprises a Windows operating system, and
wherein the second operating system comprises a Linux operating system that meets a portable operating system interface (POSIX) standard.
